(19) United States
(12) Patent Application Publication
(10) Pub. No.: US 2024/0386332 A1
(43) Pub. Date: Nov. 21, 2024

(54) RESOURCE MANAGEMENT FRAMEWORK USING MACHINE LEARNING

(71) Applicant: Dell Products L.P., Round Rock, TX (US)

(72) Inventors: Abhijit Mishra, Bangalore (IN); Madhusudhana Reddy Chilipi, Leander, TX (US); Karthik K, Bangalore (IN); Tousif Mohammed, Bangalore (IN); Panguluru Vijaya Sekhar, Bangalore (IN); Pushpa Kumar Marlapalli, Leander, TX (US); Ananth Nagaraju, Siddipet (IN); Bijan Kumar Mohanty, Austin, TX (US); Hung Dinh, Austin, TX (US); Anusha Shetty, Bangalore (IN)

(21) Appl. No.: 18/320,650

(22) Filed: May 19, 2023

(51) Int. Cl. G06N 20/20

(52) U.S. Cl. CPC G06N 20/20

(57) ABSTRACT

A method comprises collecting usage data for a plurality of automated resources integrated in a platform, computing a utilization score for one or more automated resources of the plurality of automated resources based at least in part on the usage data, and predicting a future utilization for the one or more automated resources using one or more machine learning algorithms. Integration of the one or more automated resources in the platform is controlled based at least in part on one or more of the utilization score and the future utilization.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to resource management in information processing systems.

### BACKGROUND

Platform-as-a-service (PaaS) is a service model that users can leverage to focus on developing and managing applications without worrying about the underlying infrastructure. PaaS resource utilization in an enterprise is typically not uniform across different types of platforms. The utilization can vary based on a variety of factors including, for example, behavior of applications using the PaaS, performance, scalability of each integration, integration patterns, user interests and user sentiments. While each integration in a PaaS can be created for full utilization, some integrations have a higher utilization than others.

### SUMMARY

Embodiments provide a resource management platform in an information processing system.

For example, in one embodiment, a method comprises collecting usage data for a plurality of automated resources integrated in a platform, computing a utilization score for one or more automated resources of the plurality of automated resources based at least in part on the usage data, and predicting a future utilization for the one or more automated resources using one or more machine learning algorithms. Integration of the one or more automated resources in the platform is controlled based at least in part on one or more of the utilization score and the future utilization.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts an information processing system with a resource management platform in an illustrative embodiment.

FIG. 2 depicts a process for submission and implementation of automation features according to an illustrative embodiment.

FIG. 3A depicts a screenshot of a user interface for submission of automation features in an illustrative embodiment.

FIG. 3B depicts a screenshot of a user interface summarizing a submission of automation features in an illustrative embodiment.

FIG. 3C depicts a screenshot of a user interface for accepting submitted automation features and moving the submitted automation features to a software development backlog in an illustrative embodiment.

FIG. 4 depicts a process for training and testing a machine learning model for predicting resource utilization according to an illustrative embodiment.

FIG. 5 depicts sample training data and corresponding features in an illustrative embodiment.

FIG. 6 depicts a plurality of decision trees used in connection with a random forest regressor according to an illustrative embodiment.

FIG. 7 depicts example pseudocode for importation of libraries in an illustrative embodiment.

FIG. 8 depicts example pseudocode for splitting a dataset into training and testing components and for creating separate datasets for independent and dependent variables in an illustrative embodiment.

FIG. 9 depicts example pseudocode for training and computing accuracy of a random forest regressor in an illustrative embodiment.

FIG. 10 depicts a sample generated graph of utilization scores for a plurality of PaaS resources in an illustrative embodiment.

FIG. 11 depicts a sample generated graph of a number of available resources and their corresponding statuses for a plurality of PaaS resources in an illustrative embodiment.

FIG. 12 depicts a sample generated graph of a number of available resources and their corresponding adoption tools for a plurality of PaaS resources in an illustrative embodiment.

FIG. 13 depicts a sample generated chart of statuses for a plurality of PaaS resources in an illustrative embodiment.

FIG. 14 depicts a sample generated chart of adoption rates for a plurality of PaaS resources in an illustrative embodiment.

FIG. 15 depicts a sample generated graph of target completion dates for a plurality of PaaS resources in an illustrative embodiment.

FIG. 16 depicts a sample generated graph of utilization score trends for a plurality of PaaS resources in an illustrative embodiment.

FIG. 17 depicts a process for resource management according to an illustrative embodiment.

FIGS. 18 and 19 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous and a user device receives messages without any significant time delay. Of course, it should be understood that depending on the particular temporal nature of the system in which an embodiment is implemented, other appropriate timescales that provide at least contemporaneous performance and output can be achieved.

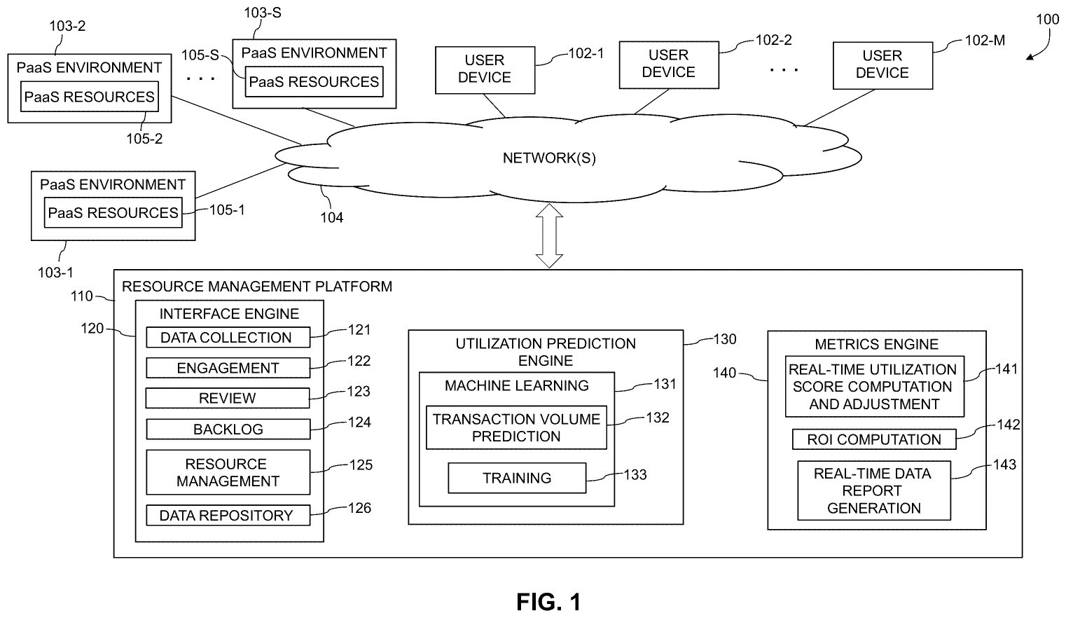

FIG. 1 shows an information processing system 100 configured in accordance with an illustrative embodiment. The information processing system 100 comprises user devices 102-1, 102-2, . . . 102-M (collectively “user devices 102”) and PaaS environments 103-1, 103-2, . . . 103-S (collectively “PaaS environments 103”). The user devices 102 and PaaS environments 103 communicate over a network 104 with a resource management platform 110. The variable M and other similar index variables herein such as K, L, S and T are assumed to be arbitrary positive integers greater than or equal to one.

The user devices 102 and one or more devices of the PaaS environments 103 can comprise, for example, Internet of Things (IoT) devices, desktop, laptop or tablet computers, mobile telephones, or other types of processing devices capable of communicating with the resource management platform 110 over the network 104. Such devices are examples of what are more generally referred to herein as “processing devices.” Some of these processing devices are also generally referred to herein as “computers.” The user devices 102 and one or more devices of the PaaS environments 103 may also or alternately comprise virtualized computing resources, such as virtual machines (VMs), containers, etc. The user devices 102 and/or one or more devices of the PaaS environments 103 in some embodiments comprise respective computers associated with a particular company, organization or other enterprise.

The terms “customer,” “administrator,” “personnel” or “user” herein are intended to be broadly construed so as to encompass numerous arrangements of human, hardware, software or firmware entities, as well as combinations of such entities. Resource management services may be provided for users utilizing one or more machine learning models, although it is to be appreciated that other types of infrastructure arrangements could be used. At least a portion of the available services and functionalities provided by the resource management platform 110 in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments.

Although not explicitly shown in FIG. 1, one or more input-output devices such as keyboards, displays or other types of input-output devices may be used to support one or more user interfaces to the resource management platform 110, as well as to support communication between the resource management platform 110 and connected devices (e.g., user devices 102 and one or more devices of the PaaS environments 103) and/or other related systems and devices not explicitly shown.

In some embodiments, the user devices 102 are assumed to be associated with repair technicians, system administrators, information technology (IT) managers, software developers, release management personnel or other authorized personnel configured to access and utilize the resource management platform 110.

The PaaS environments 103 provide frameworks where PaaS resources 105-1, 105-2, . . . 105-S (collectively “PaaS resources 105”) in each environment are integrated to provide users with a variety of services. For example, some PaaS environments 103 may provide a framework for users (e.g., developers) to create, develop and/or customize applications using the PaaS resources 105. In other non-limiting examples, some PaaS environments 103 may provide a framework for enterprises to analyze and mine data, monitor devices, and enhance applications. In some cases, PaaS environments 103 provide IT functionality, call center functionality (e.g., chatbot, virtual agent or other conversational artificial intelligence functionality), automated workload processing functionality or other types of application functionality.

The PaaS resources 105 comprise, for example, automated resources such as self-service automation (SSA) applications. SSA applications execute automated workloads or processes, and may include web-based applications with user interfaces that permit users to trigger, cancel and/or restart the automated workloads or process. SSA applications may also monitor the progress of the workloads or processes. In some cases, SSA applications may perform natural language processing (NLP), natural language understanding (NLU) and/or natural language generation (NLG) in connection with conversational artificial intelligence, query processing and/or response generation. The PaaS resources 105 may further comprise other types of applications, computing devices, software components, firmware components or other resources used to provide the services associated with a given PaaS environment 103.

As noted hereinabove, resource utilization in an enterprise is typically not uniform across different types of platforms. Current approaches are not configured for identifying how PaaS resources are being used and do predict future resource utilization. As a result, PaaS iterations may unnecessarily be configured to integrate resources that are not being utilized, while other resources which are being used with higher frequency are excluded and/or not provided with required computing power to operate effectively.

In an attempt to address the non-uniformity of resource utilization, the illustrative embodiments provide techniques to calculate an empirical value of resource utilization in each integration of a PaaS. This approach provides a useful method to provide alerts for low utilization so that resources can be decommissioned in an intelligent manner. In addition, the framework of the illustrative embodiments advantageously provides a proactive approach to predict future resource utilization for integrations in a PaaS environment. By leveraging a sophisticated machine learning regressor and training the machine learning regressor with historical resource utilization data, the illustrative embodiments provide a technical solution that uses machine learning to accurately predict transaction volume for PaaS resources. This intelligence and insight on future utilization can be used to identify more efficient PaaS configurations. The embodiments, therefore, provide predictive and prescriptive approaches to PaaS choices and design decisions for optimal utilization of resources.

The resource management platform 110 in the present embodiment is assumed to be accessible to the user devices 102 and/or PaaS environments 103 and vice versa over the network 104. The network 104 is assumed to comprise a portion of a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

Referring to FIG. 1, the resource management platform 110 includes an interface engine 120, a utilization prediction engine 130 and a metrics engine 140. The interface engine 120 includes a data collection layer 121, an engagement layer 122, a review layer 123, a backlog layer 124, a resource management layer 125 and a data repository. The utilization prediction engine 130 includes a machine learning layer 131 comprising transaction volume prediction and training layers 132 and 133. The metrics engine 140 includes a real-time utilization score computation and adjustment layer 141, a return on investment (ROI) computation layer 142 and a real-time data report generation layer 143.

The data collection layer 121 collects usage data for respective PaaS resources 105 of the PaaS environments 103. The usage data includes, for example, historical and real-time usage data comprising, for example, historical and real-time transaction data of the respective PaaS resources 105. The transaction data comprises, for example, metrics associated with a volume of transactions performed by the PaaS resources 105 such as, but not necessarily limited to, numbers of input-output (IO) operations performed by a given resource over a particular time period (e.g., IO operations per second (IOPS) over a designated period), throughput values, number of workloads processed over a given period, and/or number of requests or queries processed and/or responded to over a given period, and memory and central processing unit (CPU) utilization associated with a particular PaaS resource 105 over a designated period. The usage data, including the transaction data, identifies, for example, associated integration patterns (e.g., synchronous, asynchronous), data type (e.g., request/reply, publisher/subscriber, point-to-point, etc.), integration platform types (e.g., autonomous integration cloud (AIC), business-to-business (B2B), service-oriented architecture (SOA), etc.), quality of service (e.g., exactly once, at least once, at most once), number of publishers, number of receivers, as well as publisher and subscriber identifiers. The usage data further identifies development information associated with the PaaS resources 105 such as, for example, whether a given PaaS resource 105 has been reviewed, tested, developed and/or adopted, the number of available instances of a given type of resource, adoption tools associated with respective ones of the PaaS resource 105 and/or target completion dates.

The usage data may be extracted by the data collection layer 121 from, for example, logs of application operations (e.g., SSA application operations) that have been executed and/or failed to execute and include associated performance metrics, troubleshooting logs, system event logs (SELs), etc. The usage data may be logged by logging and/or monitoring systems such as, for example, Splunk®, Elasticsearch®, Logstash®, Kibana® (ELK) stack and/or Datadog® logging and monitoring providers. The collected historical and real-time usage data may be stored in the data repository 126.

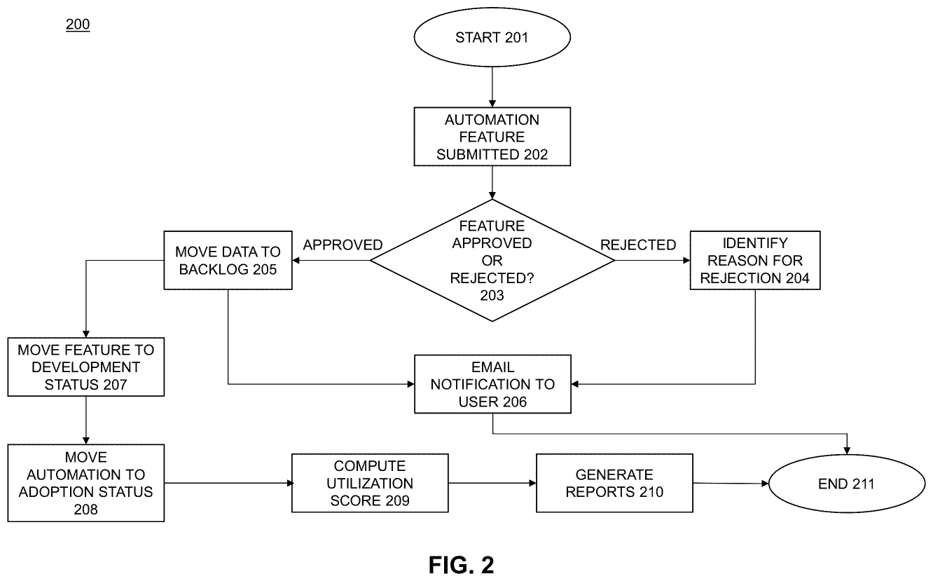

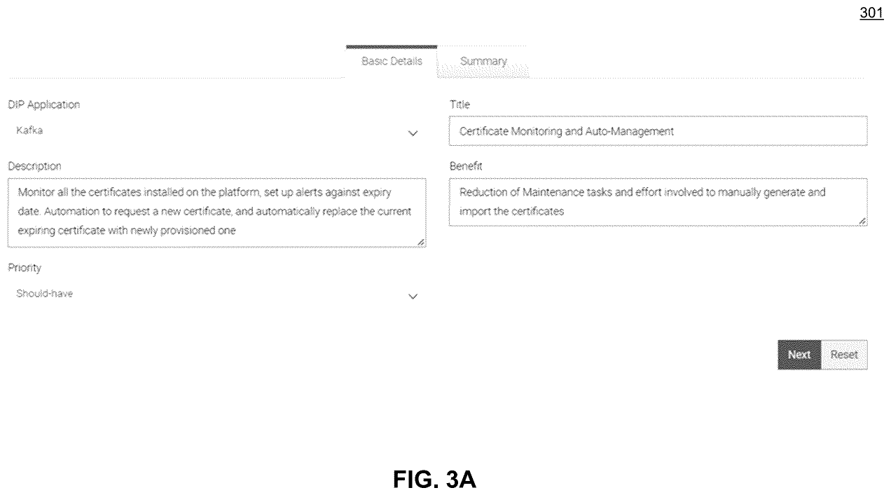

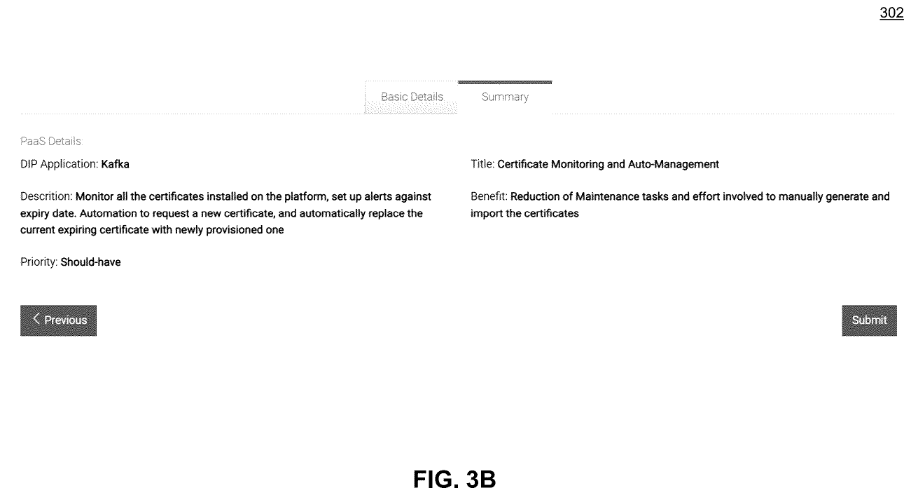

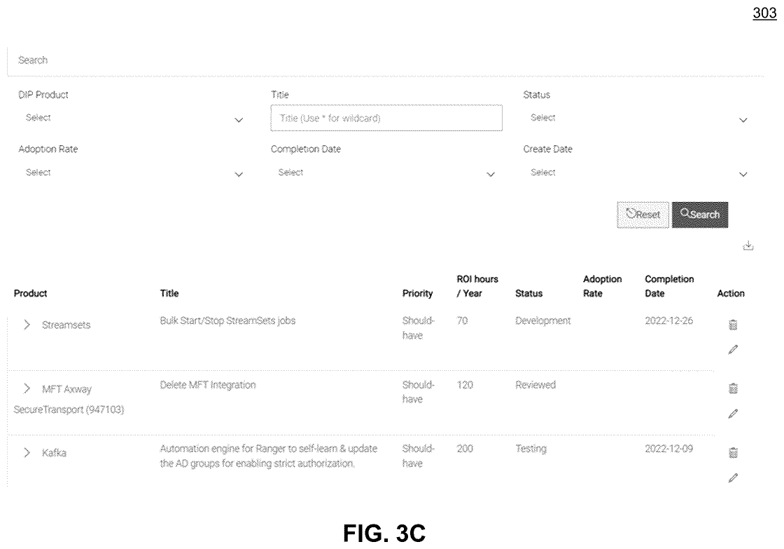

Referring to the process 200 in FIG. 2, the engagement layer 122 generates a user interface for submission of one or more features to be added to an existing PaaS resource and/or a new PaaS resource for a given PaaS environment 103. FIG. 3A illustrates an example of such a user interface 301 that may appear on a user device 102. Following the start 201 of the process 200, in step 202, automation features are submitted via the user interface 301. The automation features can be for an SSA application. For example, referring to the user interface 301 in FIG. 3A, for a data ingestion platform (DIP) application (e.g., Kafka), the features of monitoring installed certificates on a platform, setting up alerts regarding expiration dates of the certificates, automatically requesting new certificates and replacing expired certificates with newly provided certificates are submitted. As used herein, a “certificate” refers to a data file that includes information for verifying the identity of a device (e.g., server, edge device (client)). The information includes, for example, the public key, an identification of the issuing authority of the certificate (e.g., certificate authority), and an expiration date of the certificate.

The features are submitted in a description field of the user interface 301, along with a designated priority (e.g., should have), a title and an explanation of the benefits of the features. The user interface 302 in FIG. 3B which is also generated by the engagement layer 122 and can be displayed on a user device 102, includes a summary of the submission. Referring to step 203, the review layer 123 generates a user interface for a user to approve or reject one or more submitted features. For example, in the user interface 303 in FIG. 3C, features submitted for Streamsets, MFT Axway and Kafka applications are displayed for rejection or approval. The features are organized according to product (e.g., resource) and include a corresponding title. A priority, ROI (hours/year), status (e.g., development, reviewed, testing), adoption rate, completion date and action (e.g., approve or reject) associated with each feature are also depicted on the user interface 303. A user can reject or approve a given feature by respectively clicking on (or otherwise activating) the “trash can” or “pencil” icons in the user interface 303. The user interface 303 further includes editable search fields (e.g., DIP Product, Adoption Rate, Title, Completion Date, Status and Creation Date) which can be filled in by a user to search for submitted features with certain criteria specified in the editable search fields. A search can be performed based on one or more of the criteria in the editable fields.

Referring to steps 204 and 206 of the process 200, if one or more features are rejected, the review layer 123 identifies one or more reasons for the rejection, and automatically generates an electronic communication (e.g., email notification) noting the rejection and the one or more reasons for the rejection. The electronic communication is transmitted to a user device 102 associated with a user that submitted the one or more features. Following that, the process ends at step 211.

Referring to step 205 of the process 200, if one or more features are approved, the backlog layer 124 automatically adds the one or more features to a software development backlog, and automatically generating an electronic communication (e.g., email notification) indicating the addition of the one or more features to the software development backlog. The electronic communication is transmitted to a user device 102 associated with a user that submitted the one or more features. Following that, the process proceeds to step 207, where the one or more features are moved to development status. The one or more features may be automatically moved to development status or moved to development status by a user (e.g., software development personnel) via a user device 102. Then, referring to step 208, the resource management layer 125 automatically integrates the one or more features into an existing automated resource (e.g., one of PaaS resources 105) or a new automated resource in a PaaS environment 103. A new automated resource may be a PaaS resource 105 added to a PaaS environment 103.

Then, referring to step 209, once the one or more features have been implemented and are being executed in a PaaS environment 103, the real-time utilization score computation and adjustment layer 141 of the metrics engine 140 computes a utilization score for a PaaS resource 105 in which the one or more features have been implemented.

In illustrative embodiments, the real-time utilization score computation and adjustment layer 141 computes a composite utilization score based on, for example, resource automation backlog, priority and adoption rate of each resource. The utilization score is used to assess a utilization status of a resource on a scale of 1-10, with 10 being the highest. For example, in a non-limiting illustrative embodiment, the following formula (1) is used compute resource utilization score:

Utilization score=((Number of Adopted Instances of a Resource*Designated Priority Weightage for the Resource*Designated Adoption Weightage of a Resource)/(Total Number of Resource Instances*Designated Priority Weightage for the Resource))*10 (1)

In other embodiments, additional or alternative factors may be used to compute utilization score. For example, utilization score may be computed based on real-time usage data comprising, for example, real-time transaction data of a given PaaS resources 105. As noted herein above, the transaction data comprises, for example, metrics associated with a volume of transactions performed by a PaaS resource 105 such as, but not necessarily limited to, numbers of IO operations performed by a given resource over a particular time period (e.g., IOPS over a designated period), throughput values, number of workloads processed over a given period, and/or number of requests or queries processed and/or responded to over a given period, and memory and CPU utilization associated with a particular PaaS resource 105 over a designated period. Utilization score may also be computed for multiple resources together and/or for a given PaaS environment 103 based on usage of the PaaS resources in the given PaaS environment 103.

In illustrative embodiments, the real-time utilization score computation and adjustment layer 141 tracks usage over a given time period for a given PaaS resource 105, group of PaaS resources 105 and/or a given PaaS environment 103 to determine, for example, a usage trend. For example, the real-time utilization score computation and adjustment layer 141 determines based on, for example, a transaction volume of a given resource exceeding a designated threshold, that a particular PaaS resource 105 is being heavily adopted, or based on, for example, a transaction volume of a given resource being less than a designated threshold, that a particular PaaS resource 105 is being lightly adopted. The transaction volume may correspond to numbers of IO operations performed by a particular PaaS resource 105 over a particular time period (e.g., IOPS over a designated period), throughput values, number of workloads processed over a given period, and/or number of requests or queries processed and/or responded to over a given period, and memory and CPU utilization associated with the particular PaaS resource 105 over a designated period. In this situation, the real-time utilization score computation and adjustment layer 141 dynamically updates a value for “Designated Adoption Weightage of a Resource” used in formula (1) to reflect the real-time usage of a PaaS resource 105 based on whether the transaction volume threshold has been exceeded.

The usage data is collected in real-time by the data collection layer 121 in response to performance of one or more transactions by the PaaS resources 105. The real-time utilization score computation and adjustment layer 141 dynamically re-computes the utilization score for the PaaS resources 105 based at least in part on real-time changes in a volume of the one or more transactions performed by the PaaS resources 105. The dynamic re-computation cab be performed at designated times or intervals, periodically and/or in response to identified changes in transaction volume of a given resource.

Referring to step 210 of the process 200 in FIG. 2, following computation of utilization by the real-time utilization score computation and adjustment layer 141, the real-time data report generation layer 143 generates one or more data reports, which may be transmitted to a user device 102 and displayed on a user interface of the user device 102, at which point the process ends at step 211. In illustrative embodiments, the data reports comprise one or more visualizations of the usage data in real-time. The data reports may be generated in response to the collection of the usage data by the data collection layer 121, the computing of the utilization score and/or the re-computing of the utilization score.

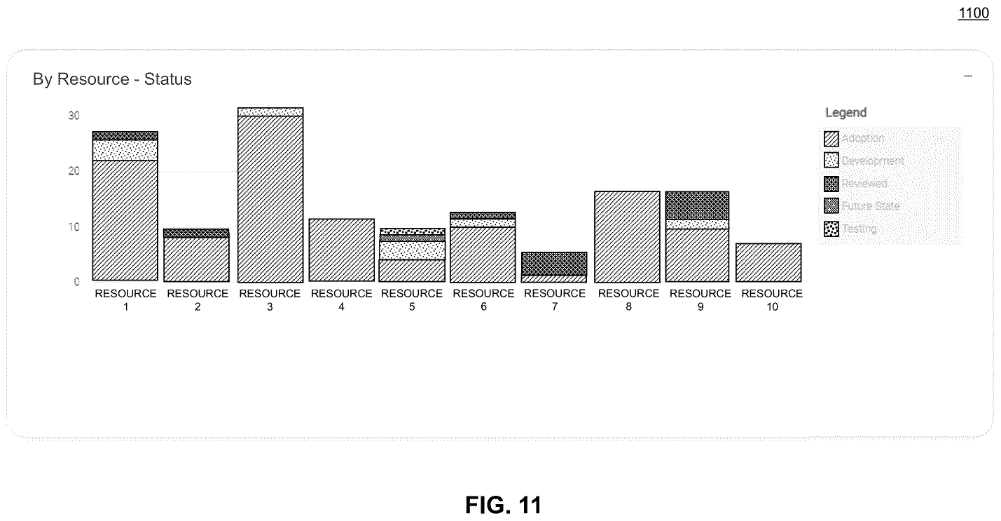

For example, the real-time data report generation layer 143 is configured to generate real-time data reports corresponding to utilization score, resource development status, adoption, completion date, and/or utilization score trend, etc. FIG. 10 depicts a sample generated graph 1000 of utilization scores for a plurality of PaaS resources 105 (e.g., Resources 1-10). Reports based on utilization score show a utilization score for each PaaS resource, providing a visualization to illustrate self-service capabilities of a resource. Some examples of the plurality of PaaS resources 105 include, but are not necessarily limited to, Autonomous Integration Cloud (AIC)-Integration Platform As-A-Service (iPaaS), Boomi, Kafka, Axway Managed File Transfer (MFT), OpenText™M BizManager™M, Oracle Service Bus, Splunk Log Miner, Streamsets, Websphere Message Queue (MQ) Service, and Integration-as-a-Service (INaaS).

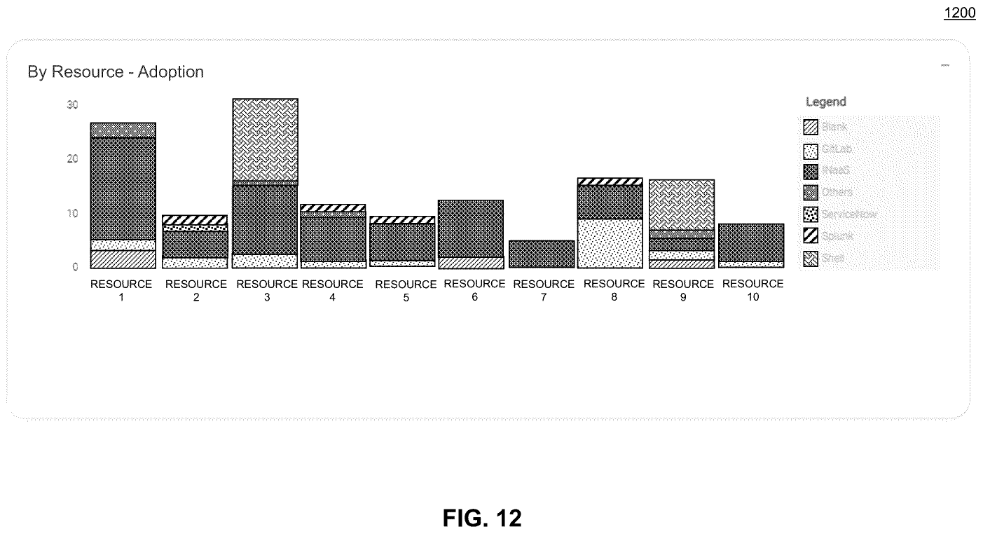

FIG. 11 depicts a sample generated graph 1100 of a plurality of PaaS resources 105 (e.g., Resources 1-10) and their corresponding statuses. Reports based on resource status provide data on resource availability and resource stage. For example, different statuses include, but are not necessarily limited to, adoption, development, reviewed, future state, testing, etc. For each resource, the number of instances of that resource that have been adopted, are in development, are being reviewed, are in a future state and are being tested is shown.

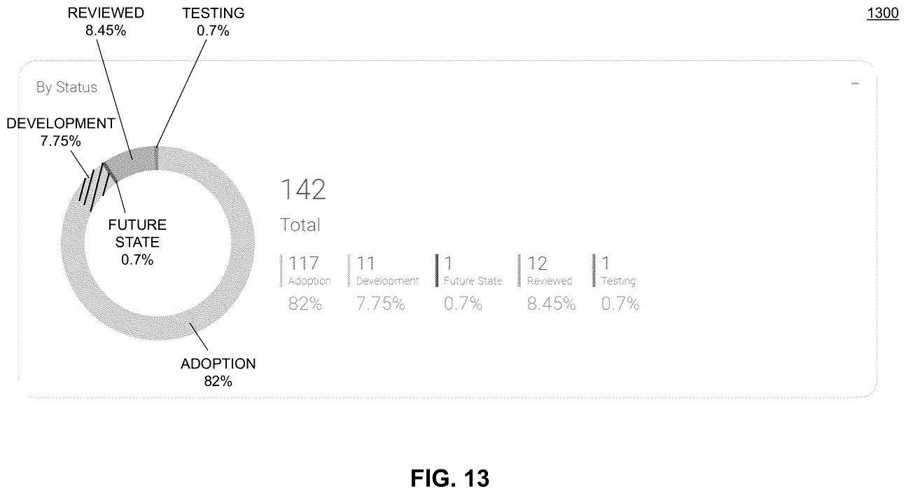

FIG. 12 depicts a sample generated graph 1200 of a plurality of PaaS resources 105 (e.g., Resources 1-10) and their corresponding adoption tools. The adoption tools may include, but are not necessarily limited to, Blanx, GitLab, iNaaS, ServiceNow, Splunk and Shell. Reports based on resource adoption provide data on how many resource instances are available and the adoption tool being used for implementation of those instances. In other words, for each resource, the number of instances of a given resource using a particular adoption tool is shown.

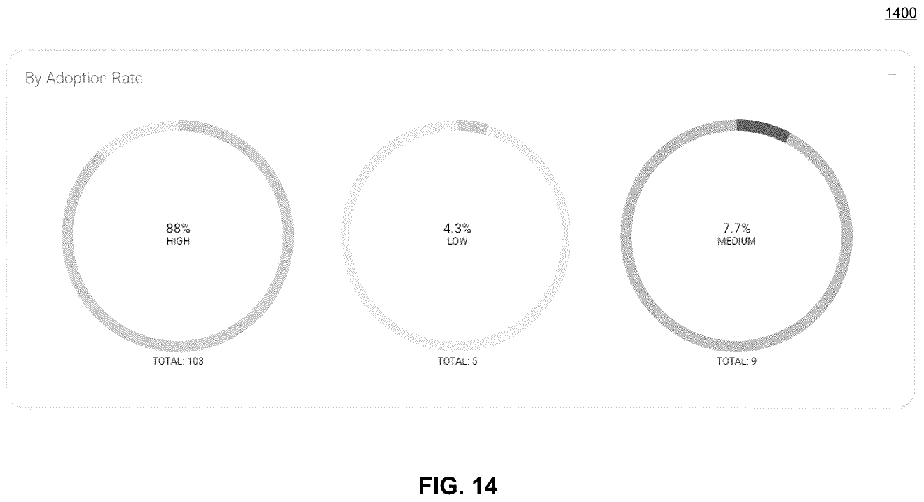

FIG. 13 depicts a sample generated chart 1300 of statuses for a plurality of PaaS resources 105. For example, FIG. 13 shows that for 142 resources, 82% (e.g., 117) have been adopted, 7.75% (e.g., 11) are in development, 0.7% (e.g., 1) are in a future state, 8.45% (e.g., 12) have been reviewed and 0.7% (e.g., 1) are in testing.

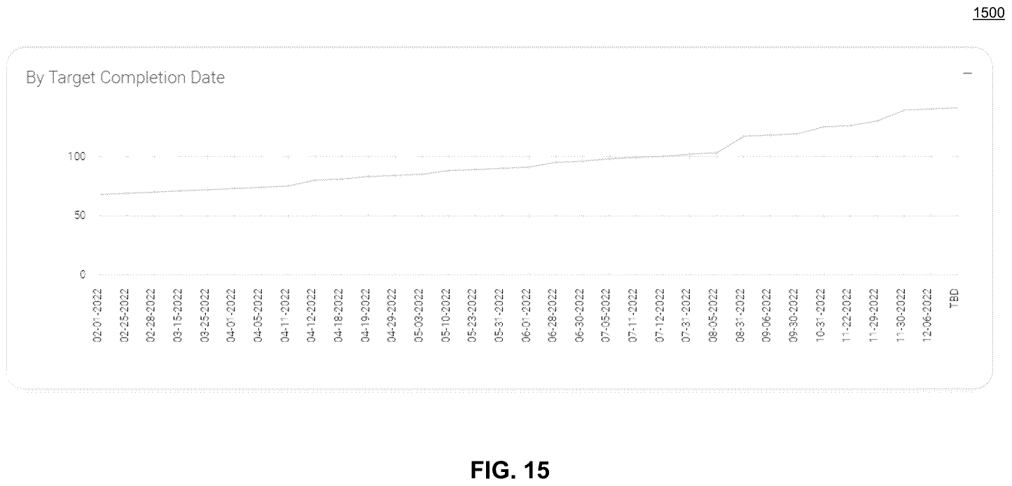

FIG. 14 depicts a sample generated chart 1400 of adoption rates for a plurality of PaaS resources 105. For example, 88% of the resources (e.g., 103) have a high adoption rate, 4.3% of the resources (e.g., 5) have a low adoption rate and 7.7% of the resources (e.g., 9) have a medium adoption rate. High, medium and low adoption rates may be defined based on data on the speed at which resources are being adopted, with high, medium and low corresponding to different speed thresholds. For example, below a first threshold corresponds to a low rate, at or above the first threshold and below a second threshold corresponds to a medium rate, and at or above the second threshold corresponds to the high rate.

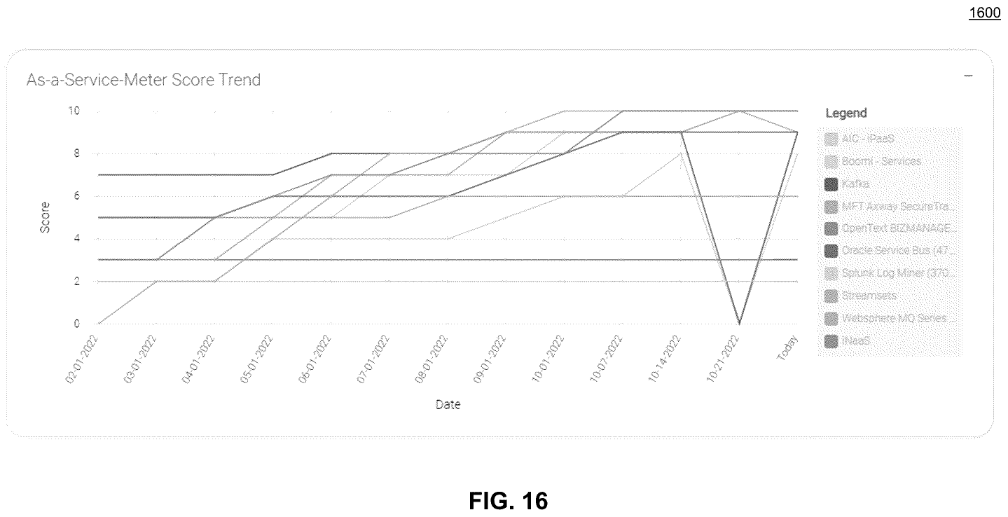

FIG. 15 depicts a sample generated graph 1500 of target completion dates for a plurality of PaaS resources 105. Reports based on target completion data provide data on the target completion date for each PaaS resource 105 to identify the availability and usage of each resource.

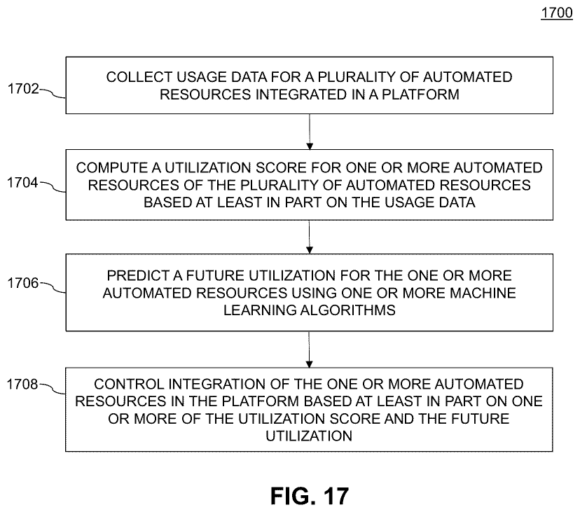

FIG. 16 depicts a sample generated graph 1600 of utilization score trends for a plurality of PaaS resources 105. Reports based on utilization score trend provide data on how utilization scores for each of a plurality of PaaS resources 105 change over a given time period (e.g., Feb. 1, 2022 to Oct. 21, 2022 or a present time). The resources may be the same resources as discussed above (e.g., Resources 1-10).

Additional reports may be based on, for example, ROI for each PaaS resource 105. The ROI computation layer 142 of the metrics engine 140 computes, for example, a monetary value of an investment versus cost to develop and execute a given PaaS resource 105.

As noted herein above, a sophisticated machine learning regressor is leveraged and trained with historical resource utilization data so that machine learning can be used to accurately predict transaction volume for PaaS resources 105. Advantageously, by inputting the features of a given PaaS resource 105, the machine learning model can be used to predict future utilization of a new or newly configured PaaS resource 105. The trained machine learning model bases the prediction on past utilization results for the same or similar types of resources and/or for the same or similar types of PaaS environments 103.

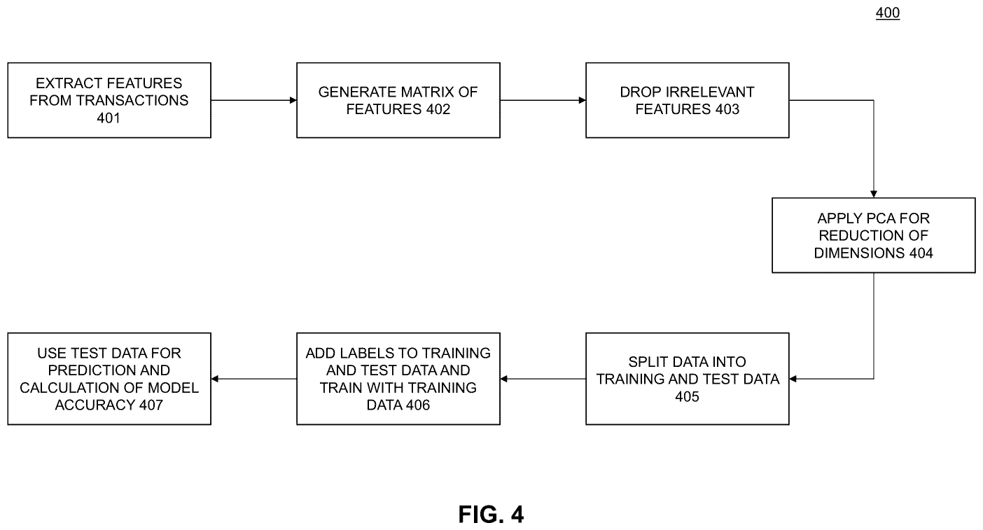

Referring to the process 400 in FIG. 4, at step 401, the data collection layer 121 extracts features from historical transaction data. As noted herein, the historical transaction data includes, for example, metrics associated with a volume of transactions performed by PaaS resources 105 such as, but not necessarily limited to, numbers of IO operations performed by a given resource over a particular time period (e.g., IOPS over a designated period), throughput values, number of workloads processed over a given period, and/or number of requests or queries processed and/or responded to over a given period, and memory and CPU utilization associated with a particular PaaS resource 105 over a designated period. The usage data identifies, for example, associated integration patterns (e.g., synchronous, asynchronous), data type (e.g., request/reply, publisher/subscriber, point-to-point, etc.), integration platform types (e.g., AIC, B2B, SOA, etc.), quality of service (e.g., exactly once, at least once, at most once), number of publishers, number of receivers, as well as publisher and subscriber identifiers. The usage data further identifies development information associated with the PaaS resources 105 such as, for example, whether a given PaaS resource 105 has been reviewed, tested, developed and/or adopted, the number of available instances of a given type of resource, adoption tools associated with respective ones of the PaaS resource 105 and/or target completion dates.

In illustrative embodiments, the data collection layer 121 performs data engineering and data pre-processing to identify and extract the features and corresponding data and metadata elements that will be influencing the utilization score predictions for new or newly configured PaaS resources 105. Referring to steps 402 and 403, in illustrative embodiments, data engineering and data pre-processing is performed to generate one or more matrices of features to identify the significance of each feature in the collected data and metadata, and drop irrelevant features and/or filter less important data and metadata elements. In step 404, data engineering and data pre-processing is used to apply principal component analysis (PCA) to reduce the dimensions and complexity of the machine learning model, hence improving the accuracy and performance of the model. In some embodiments, the data engineering and data pre-processing includes cleaning any unwanted characters and stop words from the data and metadata, and performing stemming and lemmatization, as well as changing text to lower case, removing punctuation, and removing incorrect or unnecessary characters. The processed and engineered data is stored in the data repository 126.

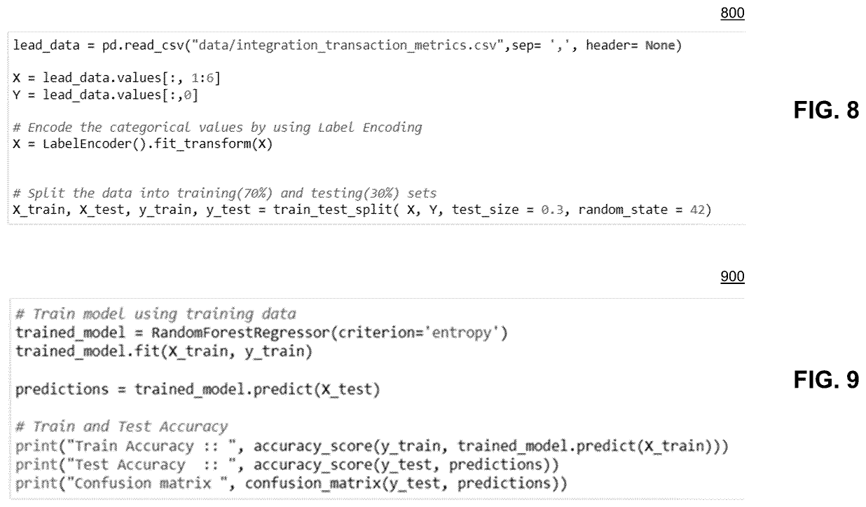

At step 405, the processed and engineered data is split into training and test datasets. As explained in more detail in connection with FIG. 8, the training set is used for training the machine learning model(s) while the test set is used for testing/validating and computing accuracy score(s) of the model(s). For example, at step 406, labels are added to the training and the test data and the training data is used to train the machine learning regressor used by the transaction volume prediction layer 132 to predict transaction volume for a given PaaS resource 105. Using the training layer 133, the transaction volume prediction layer 132 is trained with historical resource utilization data so that machine learning can be used to accurately predict future transaction volume for the given PaaS resource 105. The features of the given PaaS resource 105 (e.g., a new or newly configured PaaS resource 105) are inputted to the transaction volume prediction layer 132, which predicts future utilization of the given PaaS resource 105 based on past utilization results for the same or similar types of PaaS resources 105 and/or for the same or similar types of PaaS environments 103.

Referring to step 406 in FIG. 4, labels are added to the training and test data. The labeled training data is used to train the machine learning regressor used by the transaction volume prediction layer 132. Referring to step 407, the labeled test data is used for prediction and calculation of model accuracy.

The machine learning based regressor can predict the future volume of transactions with a high degree of accuracy. As historical transactional data of each PaaS environment 103 is logged into an enterprise logging system (e.g., Splunk® and/or ELK stacks), training data can be harvested from these systems by the data collection layer 121. As noted herein above, this multi-dimensional data includes features such as, for example, associated integration patterns (e.g., synchronous, asynchronous), data type (e.g., request/reply, publisher/subscriber, point-to-point, etc.), integration platform types (e.g., AIC, B2B, SOA, etc.), quality of service (e.g., exactly once, at least once, at most once), number of publishers, number of receivers, as well as publisher and subscriber identifiers. The multi-dimensional data is subject to PCA for dimensionality reduction. Once the data is ready, it is split into training and testing datasets.

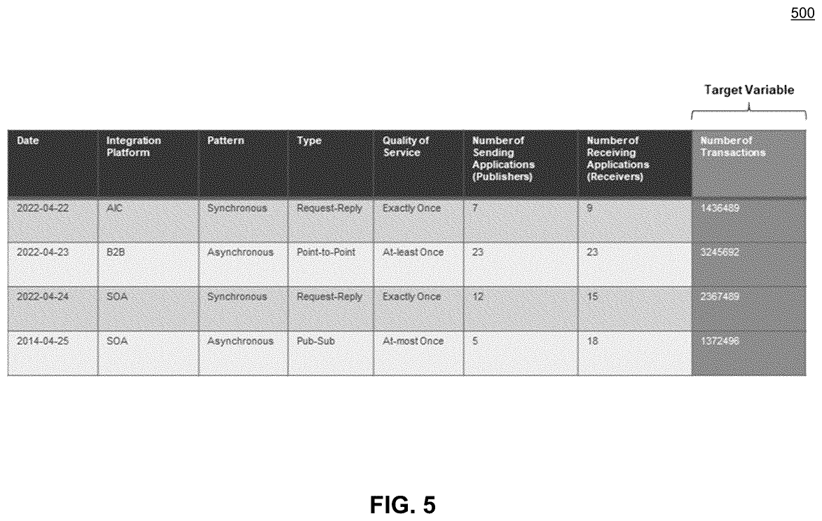

Shallow learning approaches are leveraged to build the regression model for prediction. FIG. 5 depicts a table 500 of sample historical utilization data that may be used to train the one or more machine learning models used for utilization prediction by the utilization prediction engine 130. It is to be understood that the data illustrated in table 500 is illustrative, and the embodiments are not necessarily limited to what is shown in FIG. 5. Utilization data with more or less features may be used in other embodiments. As can be seen in the table 500, the training data identifies multi-dimensional features. The features include, for example, date, integration platform, pattern, type, quality of service, number of sending applications (e.g., publishers), number of receiving applications (e.g., receivers) and number of transactions. The number of transactions is identified as the target variable in the table 500. The target variable represents what is being predicted by the machine learning layer 131 of the utilization prediction engine 130.

The utilization prediction engine 130, more particularly, the training layer 133 of the machine learning layer 131 uses the historical utilization data collected by the data collection layer 121 to train one or more machine learning algorithms used by the transaction volume prediction layer 132 to predict transaction volume for a given PaaS resource 105.

Given the complexity and dimensionality of the variety of features, illustrative embodiments utilize a shallow learning approach leveraging a decision tree-based, ensemble bagging technique with a random forest algorithm as a multi-class classification approach for predicting the class which is the transaction volume (e.g., number of transactions). The random forest algorithm is used for prediction and recommendation because of its efficiency and accuracy of processing large volumes of data. The random forest algorithm uses bagging (bootstrap aggregating) to generate predictions; this includes using multiple classifiers (e.g., in parallel) each trained on different data samples and different features. This reduces the variance and the bias that results from using a single classifier. Final classification is achieved by aggregating the predictions that were made by the different regressors.

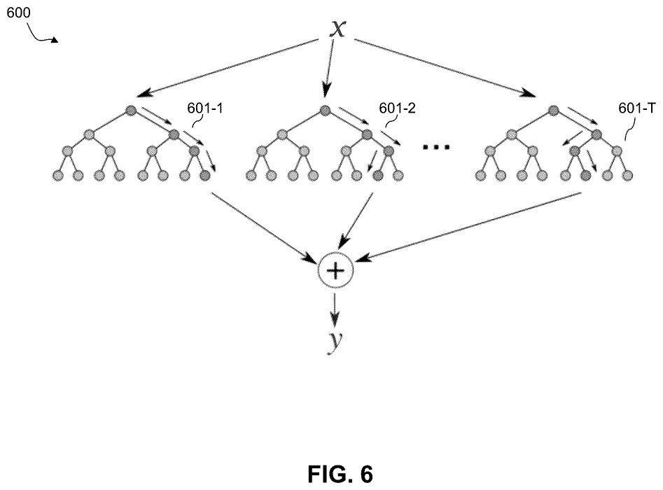

Referring to the random forest regressor diagram 600 in FIG. 6, the machine learning layer 131 constructs a plurality of decision trees 601-1, 601-2, . . . 601-T (collectively “decision trees 601”) using different features and different data samples, which reduces bias and variance as noted above. In the training process, the decision trees 601 are constructed using the training data, which comprises historical utilization data. In the testing process, data (“X dataset” in FIG. 6) comprising, for example, resource features, is inputted to the multiple decision trees 601 to generate a transaction volume value, and the final prediction Y (target variable) is determined by aggregating (e.g., averaging) the transaction volumes of the respective ones of the decision trees 601. Multiple independent variables comprise the features of the X dataset as explained hereinabove, whereas the target variable (Y value) is the future transaction volume predicted/recommended by the model. Random forest classification is based on the wisdom of a plurality of models. Instead of using just one model (e.g., decision tree) to make a prediction, a random forest technique uses multiple uncorrelated decision trees, which outperforms the methodology when using single tree. The use of multiple decision trees minimizes errors, when compared with using a single decision tree. In this model, even if some trees might yield an incorrect or less accurate result, the majority of decision trees will produce a correct or accurate result. Although three decision trees are shown, the embodiments are not necessarily limited to three decision trees, and more or less decision trees may be used.

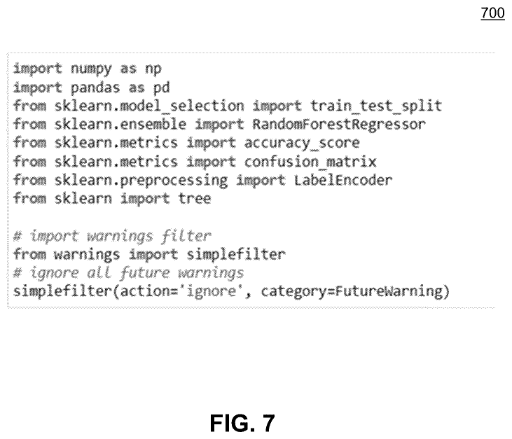

In connection with the operation of the utilization prediction engine 130, FIG. 7 depicts example pseudocode 700 for importation of libraries used to implement the utilization prediction engine 130. For example, Python, ScikitLearn, Pandas and Numpy libraries can be used. Illustrative embodiments implement regression using a random forest regressor to predict resource transaction volume.

The historical utilization data is read into a training (e.g., Pandas) data frame for building training data. A historical utilization data file including the historical utilization data is generated as a CSV file and the data is read to a Pandas data frame. According to illustrative embodiments, the encoded training dataset is split into training and testing datasets, and separate datasets are created for independent variables and dependent variables. Some embodiments use a train_test_split function of an sklearn library to split the data into training and testing sets. The training set is used for training the machine learning model(s) while the test set is used for testing/validating and computing accuracy score(s) of the model(s). In some embodiments, a training set will contain 70% of the observations, while a testing set will contain 30% of the observations. The function also separates the target variable (y) and the independent variables (X). FIG. 8 depicts example pseudocode 800 for splitting a dataset into training and testing components and for creating separate datasets for independent (X) and target (y) variables.

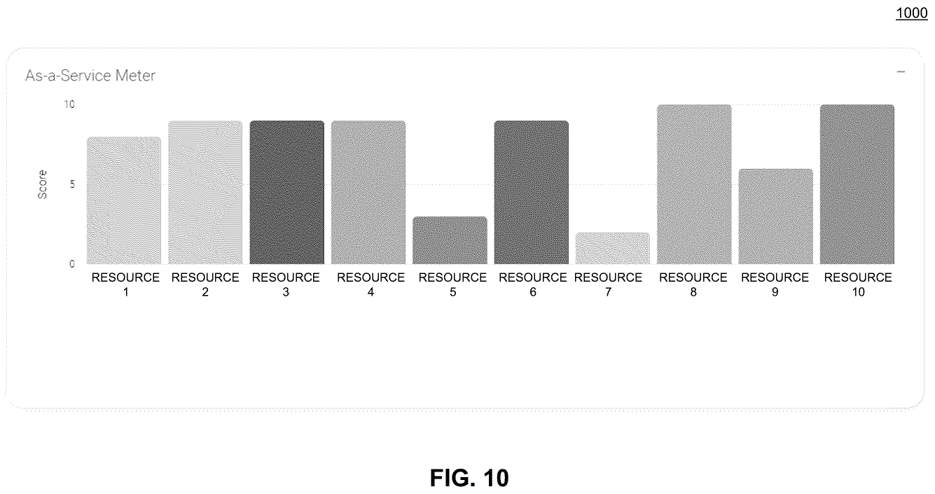

FIG. 9 depicts example pseudocode 900 for training and computing accuracy of a random forest regressor. In some embodiments, a random forest regressor is used to predict transaction volume for a given PaaS resource 105. In illustrative embodiments, the random forest regressor is created using an sklearn library with “entropy” as the criterion hyperparameter. The model is trained using training datasets, with independent variables (X_train) and a target variable (y_train). Once trained, the model is requested make predictions by passing the test data of independent variables (X_test). The predictions, accuracy and confusion matrix are printed. Hyperparameter tuning can be done to improve the accuracy of the model.

Based on predicted utilization and/or real-time utilization scores, integration of PaaS resources 105 (e.g., SSA applications) in the PaaS environments 103 is controlled. The controlling may include maintaining activation of a given PaaS resource 105 in a PaaS environment 103, deactivating the given PaaS resource 105 from the PaaS environment 103 or activating the given PaaS resource 105 in the PaaS environment 103. Such controlling is performed by the resource management layer 125 of the interface engine 120.

In some embodiments, the data repository 126 and other data corpuses, repositories or databases referred to herein are implemented using one or more storage systems or devices associated with the resource management platform 110. In some embodiments, one or more of the storage systems utilized to implement the data repository 126 and other data corpuses, repositories or databases referred to herein comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although shown as elements of the resource management platform 110, the interface engine 120, utilization prediction engine 130 and/or metrics engine 140 in other embodiments can be implemented at least in part externally to the resource management platform 110, for example, as stand-alone servers, sets of servers or other types of systems coupled to the network 104. For example, the interface engine 120, utilization prediction engine 130 and/or metrics engine 140 may be provided as cloud services accessible by the resource management platform 110.

The interface engine 120, utilization prediction engine 130 and/or metrics engine 140 in the FIG. 1 embodiment are each assumed to be implemented using at least one processing device. Each such processing device generally comprises at least one processor and an associated memory, and implements one or more functional modules for controlling certain features of the interface engine 120, utilization prediction engine 130 and/or metrics engine 140.

At least portions of the resource management platform 110 and the elements thereof may be implemented at least in part in the form of software that is stored in memory and executed by a processor. The resource management platform 110 and the elements thereof comprise further hardware and software required for running the resource management platform 110, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

Although the interface engine 120, utilization prediction engine 130, metrics engine 140 and other elements of the resource management platform 110 in the present embodiment are shown as part of the resource management platform 110, at least a portion of the interface engine 120, utilization prediction engine 130, metrics engine 140 and other elements of the resource management platform 110 in other embodiments may be implemented on one or more other processing platforms that are accessible to the resource management platform 110 over one or more networks. Such elements can each be implemented at least in part within another system element or at least in part utilizing one or more stand-alone elements coupled to the network 104.

It is assumed that the resource management platform 110 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or LXCs, or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the interface engine 120, utilization prediction engine 130, metrics engine 140 and other elements of the resource management platform 110, and the elements thereof can each be implemented in the form of one or more LXCs running on one or more VMs. Other arrangements of one or more processing devices of a processing platform can be used to implement the interface engine 120, utilization prediction engine 130 and metrics engine 140, as well as other elements of the resource management platform 110. Other portions of the system 100 can similarly be implemented using one or more processing devices of at least one processing platform.

Distributed implementations of the system 100 are possible, in which certain elements of the system reside in one data center in a first geographic location while other elements of the system reside in one or more other data centers in one or more other geographic locations that are potentially remote from the first geographic location. Thus, it is possible in some implementations of the system 100 for different portions of the resource management platform 110 to reside in different data centers. Numerous other distributed implementations of the resource management platform 110 are possible.

Accordingly, one or each of the interface engine 120, utilization prediction engine 130, metrics engine 140 and other elements of the resource management platform 110 can each be implemented in a distributed manner so as to comprise a plurality of distributed elements implemented on respective ones of a plurality of compute nodes of the resource management platform 110.

It is to be appreciated that these and other features of illustrative embodiments are presented by way of example only, and should not be construed as limiting in any way. Accordingly, different numbers, types and arrangements of system elements such as the interface engine 120, utilization prediction engine 130, metrics engine 140 and other elements of the resource management platform 110, and the portions thereof can be used in other embodiments.

It should be understood that the particular sets of modules and other elements implemented in the system 100 as illustrated in FIG. 1 are presented by way of example only. In other embodiments, only subsets of these elements, or additional or alternative sets of elements, may be used, and such elements may exhibit alternative functionality and configurations.

For example, as indicated previously, in some illustrative embodiments, functionality for the resource management platform can be offered to cloud infrastructure customers or other users as part of FaaS, CaaS and/or PaaS offerings.

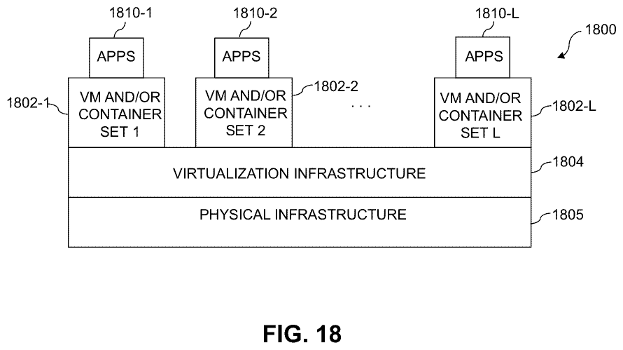

The operation of the information processing system 100 will now be described in further detail with reference to the flow diagram of FIG. 17. With reference to FIG. 17, a process 1700 for resource management as shown includes steps 1702 through 1708, and is suitable for use in the system 100 but is more generally applicable to other types of information processing systems comprising a resource management platform configured for controlling integration of resources in one or more environments.

In step 1702, usage data for a plurality of automated resources integrated in a platform is collected. In illustrative embodiments, the plurality of automated resources comprise SSA applications, and the platform comprises a PaaS computing environment. The usage data comprises transaction volume data for respective ones of the plurality of automated resources.

In step 1704, a utilization score for one or more automated resources of the plurality of automated resources is computed based at least in part on the usage data. In step 1706, a future utilization for the one or more automated resources is predicted using one or more machine learning algorithms. In illustrative embodiments, the one or more machine learning algorithms are trained with historical automated resource transaction data from one or more platforms. The one or more machine learning algorithms may comprise a plurality of decision trees, and the plurality of decision trees are respectively trained with different portions of the historical automated resource transaction data.

In step 1708, integration of the one or more automated resources in the platform is controlled based at least in part on one or more of the utilization score and the future utilization. The controlling comprises at least one of maintaining activation of the one or more automated resources in the platform, deactivating the one or more automated resources from the platform and activating the one or more automated resources in the platform.

In illustrative embodiments, the usage data is collected in real-time in response to performance of one or more transactions by the one or more automated resources. The utilization score may be dynamically re-computed for the one or more automated resources based at least in part on real-time changes in a volume of the one or more transactions performed by the one or more automated resources.

One or more visualizations of the usage data may be generated in real-time in response to at least one of the collection of the usage data, the computing of the utilization score and the re-computing of the utilization score, wherein the one or more visualizations are displayed on a user interface of at least one user device.

In illustrative embodiments, at least one user interface for submission of one or more features to be added to at least one of an existing automated resource and a new automated resource is generated. Further, at least one additional user interface is generated for approval or rejection of the one or more features to be added to at least one of the existing automated resource and the new automated resource. The one or more features to be added to at least one of the existing automated resource and the new automated resource are automatically added to a software development backlog in response to the approval. An electronic communication indicating the addition of the one or more features to the software development backlog is automatically generated, wherein the electronic communication is transmitted to a user device associated with a user that submitted the one or more features.

In illustrative embodiments, in response to the rejection of the one or more features, one or more reasons for the rejection are identified, and an electronic communication indicating the rejection and the one or more reasons for the rejection is automatically generated and transmitted to a user device associated with a user that submitted the one or more features. In one or more embodiments, the one or more features are automatically integrated into the platform in response to the approval, wherein the one or more features are integrated via at least one of the existing automated resource and the new automated resource. A utilization score is computed for at least one of the existing automated resource and the new automated resource following the integrating of the one or more features.

It is to be appreciated that the FIG. 17 process and other features and functionality described above can be adapted for use with other types of information systems configured to execute resource management services in a resource management platform or other type of platform.

The particular processing operations and other system functionality described in conjunction with the flow diagram of FIG. 17 are therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 17 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with a resource management platform as disclosed herein can provide a number of significant advantages relative to conventional arrangements. For example, the resource management platform provides a vendor agnostic framework with a set of management tools to track usage of SSA applications, to predict usage trends based on historical data, to score each instance of an SSA application on different platforms and to calculate current ROI. Such metrics can be important to enterprises in connection software development and implementation. For example, ROI and utilization scores are based on metadata attributes for hundreds of SSA instances deployed in a heterogeneous ecosystem across thousands of VMs.

As an additional advantage, the embodiments use machine learning to predict transaction volume of multiple platform resources. The embodiments advantageously leverage sophisticated machine learning regression techniques that are trained using multi-dimensional, historical utilization data to predict resource transaction volume.

Unlike conventional approaches, illustrative embodiments provide technical solutions which provide predictive and prescriptive approaches for PaaS resource selection and design. For example, the embodiments advantageously provide real-time metrics data for PaaS resources, as well as interfaces for integration of new features into PaaS resources and techniques for prediction of future utilization of such resources.

Existing approaches undesirably fail to consider the variance in utilization of automated resources across different platforms. While each integration in the PaaS is created for full utilization, the fact remains that some integrations have a higher utilization than others. To address these technical problems, the embodiments provide technical solutions which formulate programmatically and with a high degree of accuracy the capability to compute empirical values of resource utilization in each integration of a PaaS platform, thereby providing useful techniques to provide alerts on low utilization so that resources can be decommissioned in an intelligent manner. In addition, the embodiments provide technical solutions which formulate programmatically and with a high degree of accuracy the capability to use specialized machine learning algorithms to intelligently predict future utilization of resources. By training multiple decision tree classifiers with different historical utilization metrics, the random forest algorithm of the illustrative embodiments advantageously analyzes multiple combinations of usage data features to efficiently and accurately predict transaction volume for respective platform resources.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the resource management platform 110 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a resource management platform in illustrative embodiments. These and other cloud-based systems in illustrative embodiments can include object stores.

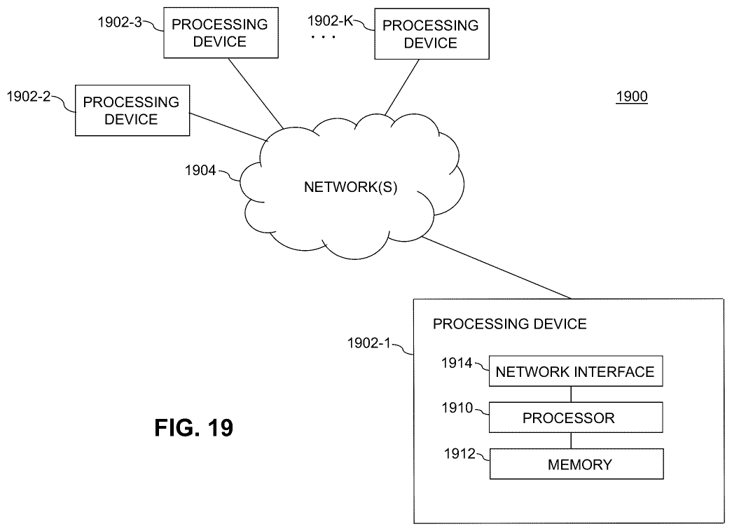

Illustrative embodiments of processing platforms will now be described in greater detail with reference to FIGS. 18 and 19. Although described in the context of system 100, these platforms may also be used to implement at least portions of other information processing systems in other embodiments.

FIG. 18 shows an example processing platform comprising cloud infrastructure 1800. The cloud infrastructure 1800 comprises a combination of physical and virtual processing resources that may be utilized to implement at least a portion of the information processing system 100. The cloud infrastructure 1800 comprises multiple virtual machines (VMs) and/or container sets 1802-1, 1802-2, . . . 1802-L implemented using virtualization infrastructure 1804. The virtualization infrastructure 1804 runs on physical infrastructure 1805, and illustratively comprises one or more hypervisors and/or operating system level virtualization infrastructure. The operating system level virtualization infrastructure illustratively comprises kernel control groups of a Linux operating system or other type of operating system.

The cloud infrastructure 1800 further comprises sets of applications 1810-1, 1810-2, . . . 1810-L running on respective ones of the VMs/container sets 1802-1, 1802-2, . . . 1802-L under the control of the virtualization infrastructure 1804. The VMs/container sets 1802 may comprise respective VMs, respective sets of one or more containers, or respective sets of one or more containers running in VMs.

In some implementations of the FIG. 18 embodiment, the VMs/container sets 1802 comprise respective VMs implemented using virtualization infrastructure 1804 that comprises at least one hypervisor. A hypervisor platform may be used to implement a hypervisor within the virtualization infrastructure 1804, where the hypervisor platform has an associated virtual infrastructure management system. The underlying physical machines may comprise one or more distributed processing platforms that include one or more storage systems.

In other implementations of the FIG. 18 embodiment, the VMs/container sets 1802 comprise respective containers implemented using virtualization infrastructure 1804 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1800 shown in FIG. 18 may represent at least a portion of one processing platform. Another example of such a processing platform is processing platform 1900 shown in FIG. 19.

The processing platform 1900 in this embodiment comprises a portion of system 100 and includes a plurality of processing devices, denoted 1902-1, 1902-2, 1902-3, . . . 1902-K, which communicate with one another over a network 1904.

The network 1904 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1902-1 in the processing platform 1900 comprises a processor 1910 coupled to a memory 1912. The processor 1910 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1912 may comprise random access memory (RAM), read-only memory (ROM), flash memory or other types of memory, in any combination. The memory 1912 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1902-1 is network interface circuitry 1914, which is used to interface the processing device with the network 1904 and other system components, and may comprise conventional transceivers.

The other processing devices 1902 of the processing platform 1900 are assumed to be configured in a manner similar to that shown for processing device 1902-1 in the figure.

Again, the particular processing platform 1900 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the resource management platform 110 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and resource management platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
collecting usage data for a plurality of automated resources integrated in a platform;
computing a utilization score for one or more automated resources of the plurality of automated resources based at least in part on the usage data;
predicting a future utilization for the one or more automated resources using one or more machine learning algorithms; and
controlling integration of the one or more automated resources in the platform based at least in part on one or more of the utilization score and the future utilization;
wherein the steps of the method are executed by a processing device operatively coupled to a memory.

2. The method of claim 1 wherein the plurality of automated resources comprise self-service automation applications.

3. The method of claim 1 wherein the platform comprises a platform-as-a-service computing environment.

4. The method of claim 1 wherein the usage data comprises transaction volume data for respective ones of the plurality of automated resources.

5. The method of claim 1 wherein the controlling comprises at least one of maintaining activation of the one or more automated resources in the platform, deactivating the one or more automated resources from the platform and activating the one or more automated resources in the platform.

6. The method of claim 1 wherein the one or more machine learning algorithms are trained with historical automated resource transaction data from one or more platforms.

7. The method of claim 6 wherein the one or more machine learning algorithms comprise a plurality of decision trees, and the plurality of decision trees are respectively trained with different portions of the historical automated resource transaction data.

8. The method of claim 1 wherein the usage data is collected in real-time in response to performance of one or more transactions by the one or more automated resources.

9. The method of claim 8 further comprising dynamically re-computing the utilization score for the one or more automated resources based at least in part on real-time changes in a volume of the one or more transactions performed by the one or more automated resources.

10. The method of claim 9 further comprising generating one or more visualizations of the usage data in real-time in response to at least one of the collection of the usage data, the computing of the utilization score and the re-computing of the utilization score, wherein the one or more visualizations are displayed on a user interface of at least one user device.

11. The method of claim 1 further comprising generating at least one user interface for submission of one or more features to be added to at least one of an existing automated resource and a new automated resource.

12. The method of claim 11 further comprising generating at least one additional user interface for one of approval and rejection of the one or more features to be added to at least one of the existing automated resource and the new automated resource.

13. The method of claim 12 further comprising:
automatically adding the one or more features to be added to at least one of the existing automated resource and the new automated resource to a software development backlog in response to the approval; and
automatically generating an electronic communication indicating the addition of the one or more features to the software development backlog, wherein the electronic communication is transmitted to a user device associated with a user that submitted the one or more features.

14. The method of claim 12 further comprising:
identifying, in response to the rejection of the one or more features, one or more reasons for the rejection; and
automatically generating an electronic communication indicating the rejection and the one or more reasons for the rejection, wherein the electronic communication is transmitted to a user device associated with a user that submitted the one or more features.

15. The method of claim 12 further comprising:
automatically integrating the one or more features into the platform in response to the approval, wherein the one or more features are integrated via at least one of the existing automated resource and the new automated resource; and
computing a utilization score for at least one of the existing automated resource and the new automated resource following the integrating of the one or more features.

16. An apparatus comprising:
a processing device operatively coupled to a memory and configured:
to collect usage data for a plurality of automated resources integrated in a platform;
to compute a utilization score for one or more automated resources of the plurality of automated resources based at least in part on the usage data;
to predict a future utilization for the one or more automated resources using one or more machine learning algorithms; and
to control integration of the one or more automated resources in the platform based at least in part on one or more of the utilization score and the future utilization.

17. The apparatus of claim 16 wherein the usage data is collected in real-time in response to performance of one or more transactions by the one or more automated resources.

18. The apparatus of claim 17 wherein the processing device is further configured to dynamically re-compute the utilization score for the one or more automated resources based at least in part on real-time changes in a volume of the one or more transactions performed by the one or more automated resources.

19. An article of manufacture comprising a non-transitory processor-readable storage medium having stored therein program code of one or more software programs, wherein the program code when executed by at least one processing device causes said at least one processing device to perform the steps of:
collecting usage data for a plurality of automated resources integrated in a platform;
computing a utilization score for one or more automated resources of the plurality of automated resources based at least in part on the usage data;
predicting a future utilization for the one or more automated resources using one or more machine learning algorithms; and
controlling integration of the one or more automated resources in the platform based at least in part on one or more of the utilization score and the future utilization.

20. The article of manufacture of claim 19 wherein:
the usage data is collected in real-time in response to performance of one or more transactions by the one or more automated resources; and
the program code further causes said at least one processing device to perform the step of dynamically re-computing the utilization score for the one or more automated resources based at least in part on real-time changes in a volume of the one or more transactions performed by the one or more automated resources.
